(19) United States
(12) Patent Application Publication
(10) Pub. No.: US 2012/0327932 A1
(43) Pub. Date: Dec. 27, 2012

(54) METHOD FOR SEARCHING FOR ROUTES IN A DATA TRANSMISSION NETWORK

(76) Inventors: Mary Luz Mouronte Lopez, Madrid (ES); Maria Luisa Vargas Marti, Madrid (ES); Paloma Martinez Sanz, Madrid (ES); Jose Luis Cedenillas Sanchez, Madrid (ES)

(21) Appl. No.: 13/509,126

(22) PCT Filed: Nov. 15, 2010
(86) PCT No.: PCT/EP2010/067462

§ 371 Date: Sep. 12, 2012

(30) Foreign Application Priority Data
Nov. 13, 2009 (ES) P200930989

(51) Int. Cl. H04L 12/56

(52) U.S. Cl. 370/389

(57) ABSTRACT

A method for searching for at least one route between an origin node and a destination node in a data transmission network, which includes two searches:
a first search wherein the origin node and destination node are fixed;
a second search wherein, if the first search is not successful, it is extended considering other alternative origin nodes and/or destination nodes, provided that they share a spatial location with the origin node and/or destination node.

### FIELD OF THE INVENTION

The present invention is applicable to the field of telecommunications and, more specifically, management systems for data transport networks.

### BACKGROUND OF THE INVENTION

One of the main problems to be solved in a data transport (or transmission) network is that of routing or, in other words, the manner in which to transfer data or passengers from an origin node to a destination node via the network. Given the vital importance of this aspect to network operation and flexibility, there are a large number of methods and algorithms which allow the more or less optimal calculation of a route between two network nodes.

In the case of packet routing data transmission networks, the information of the route is included in the coding of the final direction. Therefore, in each node routing tables are used which contain the address of neighbour nodes, due to which the network topology does not need to be known.

In small networks, said routing tables can be manually configured, but this option becomes unviable in larger-sized networks. Algorithms such as that of Bellman-Ford or link-state solve this problem by autonomously creating routing tables based on the information transported by the routing protocols themselves. See, for example:
(Richard Bellman (1958). On a Routing Problem. Quarterly of Applied Mathematics, 16(1)).
Medhi, Deepankar and Ramasamy, Karthikeyan (2007). Network Routing: Algorithms, Protocols, and Architectures. Morgan Kaufmann. ISBN 0120885883.
Doyle, Jeff and Carroll, Jennifer (2005). Routing TCP/IP, Volume I, Second Ed. Cisco Press. ISBN 1587052024. Ciscopress ISBN 1587052024.
Neil Spring, Ratul Mahajan, and Thomas Anderson. Quantifying the Causes of Path Inflation. Proc. SIGCOMM 2003.

In order to function correctly, these algorithms require the assignment of weights to each link that will help to define whether one route is better than another. These weights reflect relevant network characteristics such as bandwidth, delay or number of leaps.

The telephone network, wherethrough calls are routed based on the caller's telephone number, can be considered a particularisation of the preceding case. In these networks, pre-calculated routing tables based on a knowledge of the network topology, numbering plan and traffic data analysis are used.

Due to the geographic and hierarchical nature of the numbering plan, the prefix represents the basis of the routing system, in such a manner that the tables of each exchange only reach their maximum extension in the case of numbers corresponding to the same area. In the event that a route fails, possible alternatives are predefined without dynamic calculus.

In all the previously described scenarios, the available methods have algorithms to find the routes that are the solution to the search at hand, achieving this when possible with a greater or lesser degree of efficiency. However, in no case are alternatives proposed for those situations where there is no solution capable of fulfilling the search criteria.

### DESCRIPTION OF THE INVENTION

The present invention solves the aforementioned problem by means of a method that provides alternatives to a first search for a route between the origin node and the destination node of a network (the search having certain conditions which can be limited to said origin and destination nodes or, for example, the necessary bandwidth or other intermediate nodes wherethrough it is necessary to pass), when said first search does not achieve a valid result (i.e. a route between an origin and destination node that fulfils said requirements).

In the event that said route is not found, a second search is performed wherein the scope of the first search is broadened, considering other alternative nodes that share a spatial location with said origin end nodes (origin node and/or destination node) as possible end nodes (origin and/or destination) such as, for example, a building or a floor of a building.

Preferably, the first and/or second searches consider viable those links which, while at the time of the search cannot fulfil the required traffic demand or do not have the adequate configuration to support it, have the necessary structure to become valid links by changing their configuration.

Preferably, searches performed within the scope of the invention include a series of criteria which must be fulfilled by a route in order to be considered valid, some of which are drawn from the following list:
Maximum number of route links.
Nodes wherethrough the route must pass or nodes that must be avoided.
Links wherethrough the route must pass or links that must be avoided.

Preferably, if there are protection mechanisms that provide alternative routes to a known route in the event that it fails, the method of the invention performs a preliminary search wherein the resources (nodes and links) corresponding to the known route and its protection mechanism are considered.

Also preferably, the inclusion of a temporal parameter which indicates the time assigned to said searches is envisaged. After the indicated period of time, the results obtained are provided, even if these are incomplete.

Finally, performing the search based on dynamically updated network data is considered the preferable option, in such a manner that the real status of the network nodes and links are known when applying the search algorithms.

These and other aspects of the invention shall become apparent from the embodiments subsequently described hereunder.

### BRIEF DESCRIPTION OF THE FIGURES

With the object of helping to better understand the characteristics of the invention in accordance with a preferred example of practical embodiment thereof and in order to complement this description, the following figure has been attached as an integral part thereof in an illustrative and non-limiting manner:

FIG. 1 shows an example of the data transmission network whereto the method of the invention is applied.

### PREFERRED EMBODIMENT OF THE INVENTION

In this document, the term “comprises” and its derivations (such as “comprising”, etc.) shall not be understood to be excluding, i.e. these terms should not be interpreted in such a manner as to exclude the possibility of including more elements, stages, etc. in that being described and defined.

In accordance with a preferred embodiment of the invention, the following must be stored in the network:
Locations defined in the network, for example buildings.
Units within each location.
Ports/points within each unit.
Links (routes) between units and their vacant capacity (number and type of signals they accept). Their capacity expansion possibilities are defined by the classification of the possible links in a transmission network and its possible configurations.
Synchronous protection structures defined in the network, defined by the equipment and links that form them.

Maintenance of this information is dynamic and is modified with each update that is produced in the associated transmission plant (registration and unregistration of locations, equipment and ports, registration, unregistration, occupation and modification of the configuration of links).

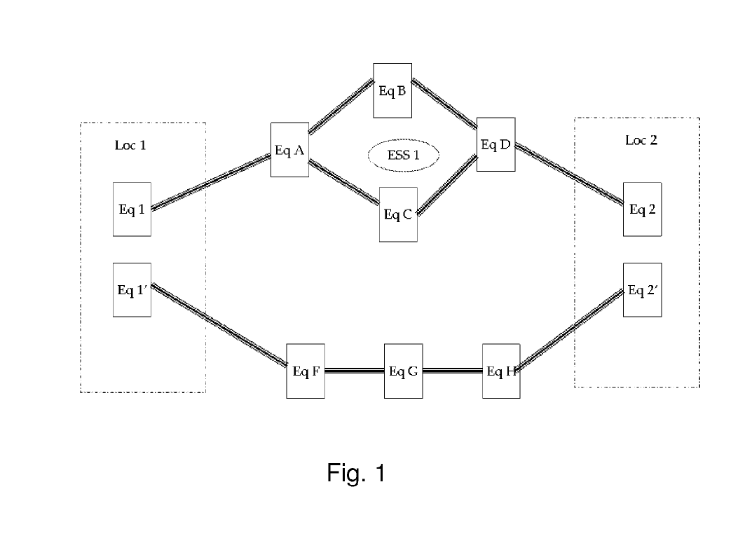

FIG. 1 shows a data transport network exemplifying the method of the invention. In said figure, the location Loc1, where units Eq1 and Eq1′ are located, and location Loc 2, where units Eq2 and Eq2′ are located, appear defined. The rest of the units EqA . . . EqH complete the network. Specifically, units EqA, EqB, EqC and EqD form the synchronous protection structure SS1.

In order to start the search, the preferred embodiment of the method of the invention receives the following input data:
Type and number of routes being sought.
The termination points or ports wherebetween we wish to find the route. Depending on the desired route technology, the ends that define it will be of a different class.
The characteristics of the route being sought:
   Complete vacant route or route that simply has the required capacity.
   Existing route or route available after performing configuration modification operations.
   Route between two defined units or between locations, depending on the limitations of the network technology.
   Maximum number of route links.
The boundary conditions that limit the search:
   Units wherethrough we want or do not want the route to pass.
   Network routes wherethrough we want or do not want to pass.
   Synchronous structure wherein the route must be contained: ring structures are defined within a transmission network wherein traffic usually circulates along one branch, the other being available for use in the event of failure. These rings are known as synchronous structures. We may wish to obtain routes that maintain the same initial protection mechanisms.
Characteristics of the resources we wish to use:
   Network types to be used (SDH, WDM).
   Operational or faulty routes.
   Fully functional or temporary routes.

These data are used to locate the end units of the route and the characteristics of the resources to be used, whereupon the different searches are performed.

The first search mode implies fixing an origin node (for example, Eq1) and a destination node (for example, Eq2) and attempting to locate and establish a route therebetween that will verify the search conditions. The manner in which to advance along the network topology is to obtain the units following that wherein it is located, which are connected through viable routes, and retreat when there is no additional possibility and the end of the route has not been reached. In the example of the figure, the route formed by Eq1, EqA, EqB, EqD y Eq2 would thus be determined or by substituting EqB for EqC.

The second search mode implies extending the first mode by flexibilising the origin and destination node conditions on allowing substitution of said nodes for others that share the same location. Once again, if the origin node is Eq1 and the destination node is Eq2, and in this case the structure ESS1 is not available or for example it does not provide the necessary bandwidth to fulfil the search conditions, the search is extended, considering Eq1′ as a possible origin node (as it shares location Loci with Eq1) and Eq2′ as a possible destination node (as it shares location Loc2 with Eq2).

Finally, in the event of failure, in order to leverage the protection provided by a synchronous structure, we will attempt to locate a route that passes exclusively through the units that form it. In the example of FIG. 1, if the search is produced because there was communication between Eq1 and Eq2 through EqB and EqB fails, a new route would be established through EqC, which forms part of the same synchronous structure ESS1. The manner in which to advance along the network topology is to obtain the locations following that wherein it is located, which are connected through viable routes, and retreat when there is no additional possibility and the end of the route has not been reached.

Fulfilment of the restrictions on the routes obtained is verified, ruling out those where they are not verified. These restrictions are related to usable network elements and to maximum route length.

In order to ensure the usefulness of the search it is limited by a timer, in such a manner that on expiry the routes obtained are reported even if the requested limit is not reached.

The invention is obviously not limited to the specific embodiments described herein, but rather also encompasses any variation that could be considered by any person skilled in the art (for example, in terms of selection of components, configuration, etc.), within the general scope of the invention, as defined in the claims attached hereto.

1. A method for searching for at least one route between an origin node and a destination node of a data transmission network, said network comprising a plurality of nodes and links, where said method comprises performing a first search for said at least one route using search criteria that must be fulfilled by a route in order to be the solution of the first search, wherein said method also comprises, if said first search does not find a route that fulfils the search criteria, performing a second search wherein one or both of the following extensions is included:
consider at least one node that shares a spatial location with the origin node of the first search as an alternative origin node; and
consider at least one node that shares a spatial location with the destination node of the first search as an alternative destination node.

2. A method according to claim 1, wherein the search criteria are selected from among all or a subset of the following criteria:
maximum number of route links;
specific nodes that must be contained in the route;
specific nodes that must not be contained in the route;
specific links that must be contained in the route; and
specific links that must not be contained in the route.

3. A method according to claim 1, wherein if the first search does not find a route that fulfils the search criteria using the current configuration of the links at the time of the search, said first search is extended considering an alternative link configuration.

4. A method according to claim 1, wherein if the second search does not find a route that fulfils the search criteria using the current configuration of the links at the time of the search, said first search is extending considering an alternative link configuration.

5. A method according to claim 1, wherein the first search and the second search comprise a temporal parameter that indicates the period of time after which, if a search has not obtained a route that fulfils the search criteria, said search is stopped and the results obtained until that moment are reported.

6. A method according to claim 1, wherein information relative to the status of the network nodes and links is dynamically updated.

7. A method according to claim 1, wherein said method also comprises a preliminary search limited to a network formed exclusively by nodes of an already known route between the origin node and the destination node, and nodes that form part of a protection system of said known route.
